(19) United States
(12) Patent Application Publication
(10) Pub. No.: US 2024/0075323 A1
(43) Pub. Date: Mar. 7, 2024

(54) FACEPIECE INCLUDING AIRFLOW BAFFLE WITH AN ANTIPATHOGEN SURFACE

(71) Applicant: LCP Medical Technologies, LLC, Rogers, MN (US)

(72) Inventor: James Rathburn, Rogers, MN (US)

(21) Appl. No.: 18/262,895

(22) PCT Filed: Jan. 27, 2022
(86) PCT No.: PCT/US2022/014018

§ 371 Date: Jul. 25, 2023

Related U.S. Application Data
(60) Provisional application No. 63/142,422, filed on Jan. 27, 2021.

(51) Int. Cl. A62B 23/02; A41D 13/11

(52) U.S. Cl. CPC A62B 23/025; A41D 13/1138; A41D 13/1161; A41D 13/1192; A62B 18/084

(57) ABSTRACT

A facepiece having one or more airflow baffles that have an antipathogen surface is disclosed. The facepiece has a main body with a geometry configured to fit on a human face and cover the human's mouth and nose. The main body defines an interior cavity between the main body and the human's face. One or more straps extend from the main body and are configured to extend around the ears or head of a human such that the main body is held on the human's face. The facepiece includes one or more baffles disposed on the main body and in an airflow path between the interior cavity and an external environment. The one or more baffles have a first surface disposed to deflect air traveling along the airflow path. The first surface has a metal layer exposed to air traveling along the airflow path.

### RELATED APPLICATIONS

This application claims the benefit of U.S. Provisional Application No. 63/142,422, filed on Jan. 27, 2021, entitled “PLANAR ANTI-PATHOGEN STRUCTURE SUSPENDED WITHIN THE AIR FLOW PATH WITHIN A PROTECTIVE FACIAL MASK OR RESPIRATOR”, which is hereby incorporated herein by reference.

### BACKGROUND

Traditional facial masks used for medical situations range from basic cloth patches that cover the mouth and nose, to more elaborate formed structures that have fibrous structures that create a filter effect for air that is breathed in by the user as well as exhaled by the user. In some cases, the filter effect is directed at protecting the user from inhaled pathogens or contaminants, and in some cases the intent is to prevent the user from exhaling pathogens or infections particles. In general, most commercially available respirators are intended for a one time use and discarded. They are difficult or expensive to sterilize and return to as new condition. In addition, most if not all commercially available respirators are designed and used to reduce exposure to pathogens and do not attack the potential pathogens themselves.

### BRIEF DESCRIPTION

Embodiments described herein provide for a facepiece with a main body having a geometry configured to fit on a human face and cover the human's mouth and nose. The main body defines an interior cavity between the main body and the human's face. One or more straps extend from the main body and are configured to extend around the ears or head of a human such that the main body is held on the human's face. The facepiece includes one or more baffles disposed on the main body and in an airflow path between the interior cavity and an external environment. The one or more baffles have a first surface disposed to deflect air traveling along the airflow path. The first surface has a metal layer exposed to air traveling along the airflow path.

### DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A and 1B are perspective views of an example facepiece that includes one or more baffles to disable pathogens in an airflow path;

FIG. 2 is a cross-sectional view of an example main body of a facepiece having a baffle therein;

FIG. 3 is front view of an example baffle having a single contiguous antipathogen surface without apertures extending therethrough;

FIG. 4 is front view of another example baffle having a plurality of flaps configured to flex in response to airflow incident thereon;

FIG. 5 is a cross-sectional view of an example portion of a main body having a baffle with flaps therein;

FIG. 6 is a front view of a pinwheel spacer layer from the portion of the main body of FIG. 5;

FIGS. 7 and 8 are front views of other example baffles having a plurality of flaps therein;

FIG. 9 is a front view of an example baffle having a plurality of apertures extending therethrough;

FIG. 10 is a front view of another example baffle having a plurality of apertures extending therethrough;

FIG. 11 is a cross-sectional view of an example baffle having topographical features defined therein;

FIG. 12 is a top view of the baffle of FIG. 11 showing the topographical features;

FIG. 13 is a cross-sectional view of another example baffle having topographical features defined therein;

FIGS. 14 and 15 are cross-sectional views of example baffles having a reaction enhancing coating on the antipathogen layer;

FIG. 16A is front view of an example facepiece having a baffle formed in polymer layers that are contiguous with the main body; and

FIG. 16B is a cross-sectional view of a facepiece having an exchangeable baffle cartridge removably secured thereto.

### DETAILED DESCRIPTION

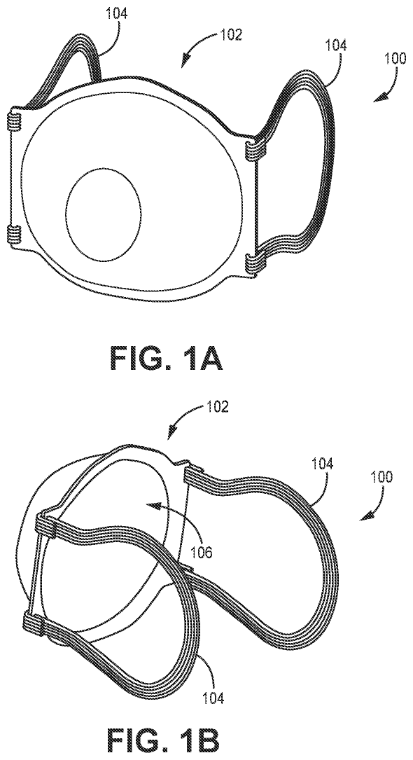

FIGS. 1A and 1B are perspective views of an example facepiece. 100 that includes one or more baffles configured to disable pathogens in an airflow path of the facepiece 100. The example facepiece 100 is a standalone respirator designed to be worn by a human user and to filter air flowing to and/or frons the user's mouth and nose. In other examples, the facepiece 100 can be a standalone facial mask (e.g., a cloth mask) or a mask configured to be coupled to a supply of gas, such as a mask for a continuous positive airway pressure (CPAP) machine or ventilator.

Facepiece 100 includes a main body 102 having or more straps 104 extending therefrom. The main body 102 defines an interior cavity 106 and is configured to cover a mouth and a nose of a user. In this example, the main body 102 is sufficiently rigid to maintain its overall shape during normal care on and off of a user's face. Example materials that are sufficiently rigid include melt blown GSM materials used in conventional facial masks and respirators, polymers, including thermoelastic polymers such as liquid crystal polymer (LCP), polyimide, polyolefin, Polycarbonate, PEI, Acrylic, Silicone, Neoprene, and others. Liquid Crystal Polymer (LCP) is a thermoplastic material that can be shaped, formed, and molded. LCP is impervious to moisture and is biocompatible. In still other examples, an insufficiently rigid material (e.g., cloth fabric) can be used along with a rigid frame to provide an overall rigid geometry for the body 102. The interior cavity 106 is sized such that the user's nose and mouth fit within the cavity 106. In this example, the main body 102 has a generally concave geometry defining a single depression large enough to cover both the user's nose and mouth. In other examples, other geometries can be used.

In one example, main body 102 has a construction based upon Polycarbonate or Acrylic polymers that provide mechanical infrastructure to incorporate multiple components and features while being optically clear to allow for the users face and facial expressions to be viewed while conventional respirators block the view of the face. These polymers will typically yield a rigid structure but depending on the design the facepiece 100 could be made flexible or partially flexible for reasons such as flat storage or distribution.

The general shape and appearance of the main body 102 and overall respirator can be generally curvilinear and in basic terms serves as the structure that holds and presents the filtration and anti-pathogen structure at the proper location within the airflow path. The structure also serves as the skeleton for arranging and attaching various components that provide features such as facial sealing, respirator retention on the user's head, filter replacement, electronics integration, filter attachment etc.

In still other examples, the main body 102 can be flexible in nature, such that main body 102 has no rigid three-dimensional shape. In such examples, the main body 102 takes a generally concave geometry that covers the user's nose and mouth upon being strapped to the user's face. An example of such a flexible material is a cloth fabric, for example, composed of cotton, nylon, wool, silk, or a combination thereof.

The one or more straps 104 are configured to hold the facepiece 100 onto the face of the user. In this example, the one or more straps 104 are configured to wrap around the ears of the user, but other straps can be used such as one or more straps extending around the back and/or top of the user's head. In use, the facepiece 100 is configured to be placed over the mouth and nose of a user such that the outer rim 108 of the main body 102 contacts the user's face around the mouth and nose.

The facepiece 100 provides one or more airflow paths for air to flow between the interior cavity 106 and the external environment while the facepiece 100 is being worn. Accordingly, the airflow paths provide a path for a user's breath to enter and/or exit the interior cavity 106 as the user inhales and/or exhales while wearing the facepiece 100. In some examples, the main body 102 is composed of materials that provide airflow paths across the entirety of the main body 102, such as is the case with cloth fabric or melt blown GSM material. In other examples, the main body 102 is composed of materials, such as a thermoelastic polymer, that blocks airflow between the interior cavity 106 and the external environment. In such other examples, the main body 102 defines one or more passages through the impervious material, wherein the passages which provide airflow paths from the interior cavity 106 to the external environment.

The facepiece 100 also includes one or more antipathogen baffles on the main body 102. The baffle(s) are disposed in an airflow path of the main body 102 and positioned to deflect the air traveling along the airflow path. The baffles have one or more antipathogen materials thereon that are configured to interact with the air as it travels along the airflow path. In an example, one or more anti-pathogen materials are disposed on one or more surfaces on which the air traveling along the airflow path is incident. Thus, air traveling along the airflow path is forced into contact with the anti-pathogen material. The antipathogen material can then act to disable viruses and bacteria in the air as it travels between the interior cavity 106 and the external environment. In an example, the antipathogen material includes a metal layer that is exposed to the air on the surface of the baffle. In an example, the metal layer includes one or more metals and/or metal oxides selected from the group consisting of copper, silver, zinc, nickel, copper oxide, silver oxide, and zinc oxide. In such an example, the baffle can be composed of solid metal (e.g., copper) or can be composed of a substrate (e.g., LCP) having a metal layer on one or both sides thereof. In some examples, the antipathogen layer can be composed solely of a metal such as copper, silver, or zinc (e.g., at least 90%, 96%, or 99.9% pure copper, silver, and/or zinc). The exposed metal layer can be, but need not be, visibly exposed. That is, the metal layer can be covered with one or more layers of material that allows the air in the airflow path to travel through the material and contact the metal layer on its way through the main body 102 of the facepiece 100.

The main body 102 and the baffles are configured such that the air is directed against the exposed antipathogen material as the air travels into and/or out of the airflow path. Directing the air flow against the exposed antipathogen material can cause pathogens into the air flow to contact the antipathogen material, which will then disable the pathogens, such that they are destroyed or otherwise rendered inactive. As used herein an antipathogen material is a material that is effective at disabling, killing, and/or destroying viruses and microbes, such as bacteria and other microorganisms. In this way, the facepiece 100 is configured to direct the air flow between the interior cavity 106 and the external environment, such that the air comes into contact with exposed antipathogen material as it is flowing through the passages, thereby disabling pathogens in that air.

In an example, the airflow paths through the main body 102 can be sufficiently tortuous and small that pathogens are also captured (filtered out) as the air passes through the main body 102. For example, the airflow paths can capture sufficient pathogens that the facepiece 100 meets the N95 standard for respirators in the United States of America.

In an example, the baffle(s) in the main body 102 are rigid such that they are not significantly bendable by hand (e.g., more than 10 degrees). In another example, the baffle(s) are bendable by hand (e.g., more then 10 degrees), but have an elastic memory such that the baffle(s) maintain their shape absent forces bending the baffle.

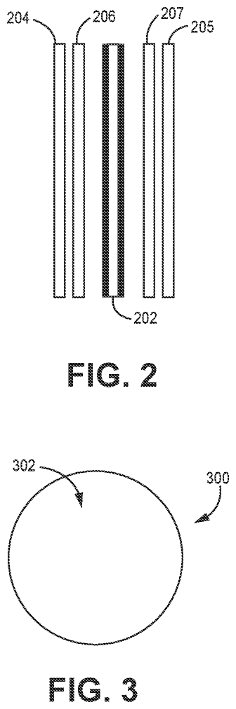

FIG. 2 is a cross-sectional view of an example main body 102 of the facepiece 100 having a baffle 202 disposed therein. The main body 102 is composed of respective outer barrier layers 204, 205, which can be materials that provide rigidity to the main body 102, such as a melt blown GSM material, or materials such as a cloth fabric that simply provide a barrier for the underlying filter layer 206, 207. In an example, the barrier layer 204, 205 extends generally across the entirety of the main body 102. The barrier layer 204, 205 can either allow airflow paths across the entirety of the surface, as in a cloth fabric, or can provide one or more defined passageways for airflow as discussed above. Underneath the barrier layer 204, 205 can be one or more filter layers 206, 207. The example shown in FIG. 2 includes two filter layers 206, 207, a first filter layer 206 underneath the first barrier layer 204 and a second filter layer 207 underneath the second barrier layer 205 that is reverse of the first barrier layer 204. In other examples, only one or more than two filter layers can be included. The main body 102 also includes one or more antipathogen baffles 202 suspended within. The one or more antipathogen baffles 202 have antipathogen material(s) on one or more surfaces thereof and as described above, are disposed in an airflow path through the main body 102. In the example shown in FIG. 2, the baffle 202 has antipathogen material on both major surfaces, such that air flowing in both directions is incident on a surface of antipathogen material. The baffle 202 can have an appropriate size such that airflow incident on the baffle 202 contacts that baffle and flows across the antipathogen surface toward the edge of the baffle 202, This flow across the surface provides increased time of contact between the air and the antipathogen material. Although only a single baffle 202, multiple baffles can be disposed in the airflow path to provide increased contact between the airflow and the antipathogen material.

In the example shown in FIG. 2, the baffle 202 includes a substrate 208 having a layer 210, 211 of antipathogen material on both major sides thereof. The substrate can be composed of any suitable material, such as LCP. In an example, the substrate 208 has a thickness in the range of 25 to 200 microns. In an example, the antipathogen material is a metal layer deposited on the substrate. In an example, the metal layer has a thickness in the range of 25 to 50 microns. In other examples, the baffle 202 can be composed differently, such as being composed of solid metal.

FIG. 3 is an example baffle 300 having a single contiguous antipathogen surface 302 without apertures extending therethrough. The contiguous antipathogen surface is intended for air flow to be incident thereon and be deflected across the surface toward an edge 302 of the surface. One or more of such baffles 300 could be disposed in a spaced apart relationship within an airflow path. Thus, air traveling along the airflow path would be incident on one or more of the baffles 300 and would be deflected to flow around the edge of the baffles 300 and through the gaps between the solid baffles 300 if there are more than one baffle 300. For example, one or more baffles 300 could be integrated in the material forming the main body 102 of the facepiece, Although the example baffle 300 shown in FIG. 3 is circular in shape, other shapes can also be used.

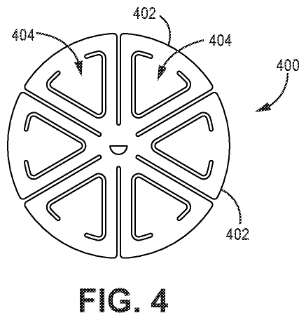

FIG. 4 is another example baffle 400. Baffle 400 defines a plurality of flaps 402, 404 that are configured to flex slightly in response to air flow into and/or out of the facepiece. The flex in the flaps 402, 404 allows for air to flow past the baffle 400 while being incident on the surfaces of the baffle 400. The flex, however, is kept low (e.g., less than 30 degrees from normal) such that the air flows against the angled flaps 402, 404 as it travels through the baffle 400. In an example, the one or more flaps 402, 404 are configured to flex both inward and outward to allow air to flow both inward and outward past the flaps 402, 404. In another example, a first one or more flaps 402 are configured to flex in one direction (e.g., inward for incoming air) and a second one or more flaps 404 are configured to flex the opposite direction (e.g., outward for outgoing air). The baffle 400 can be composed of a polymer substrate having an antipathogen (e.g., copper) layer on both sides of the polymer layer. In an example, the baffle 400 is less than 300 microns thick. The thinness of the baffle 400 can enable the flaps to flex. In some examples, reliefs to aid in flexibility of the flaps 402, 404 are added by cutting, etching, or otherwise removing metal and polymer windows (cut-outs) so the flexure region focuses on an area that remains undisturbed. The flexure can also be enhanced by removing metal from the polymer at the bend regions such that only the flexural modulus of the polymer is a factor.

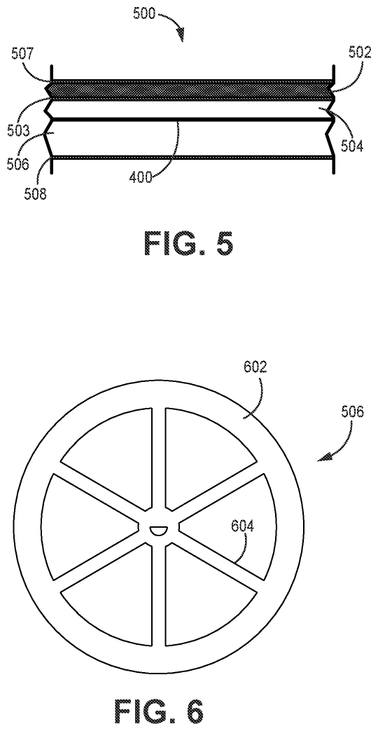

FIG. 5 is a cross-sectional view of an example portion 500 of a main body 102 that includes a baffle 400 defining a plurality of flaps 402, 404. The main body portion 500 includes a filter layer 502 in accordance with the filter layers described above. In an example, the filter layer 502 is composed of cotton. The main body portion 500 also includes a ring spacer layer 504 with a fine mesh layer 503 between the ring spacer layer 504 and the filter layer 502. The main body portion 500 also includes a pinwheel spacer layer 506 and the baffle 400 disposed between the ring spacer layer 504 and the pinwheel spacer layer 506, Additional fine mesh layers 507, 508 can be provided on the outer sides of the main body portion 500.

FIG. 6 is a front view of the pinwheel spacer layer 506. The baffle 400 is configured to contact the pinwheel spacer 506 shown in FIG. 6, The pinwheel spacer 506 includes an outer ring 602 that contacts an outer edge of a first plurality of larger flaps 402 defined in the baffle 400, The pinwheel spacer 506 also includes a plurality of spokes 604 that extend from the outer ring 602 and contact the larger flaps 402 along respective sides thereof. The contact between the pinwheel spacer 506 and the larger flaps 402 prevents the larger flaps 402 from flexing towards the pinwheel spacer 506. In an example, the baffle 400 is secured to the pinwheel spacer 506 proximate a center thereof. The ring spacer 504 has an outer ring without spokes. In an example, the ring spacer 504 is composed of PSA will go around the periphery of the baffle 400. The ring spacer can be about 5 mm wide and can be placed on the pinwheel spacer 506. The outer ring of the ring spacer 504 is disposed outward of the larger flaps 402, such that the larger flaps 402 can flex into the single large aperture formed inside the outer ring of the ring spacer 504. In this way, the ring spacer 504 and pinwheel spacer 506 enable the larger flaps 402 to flex one way and restrict them from flexing the other way.

The baffle 400 also defines a plurality of smaller flaps 404. In this example, the smaller flaps 404 are defined within the larger flaps 402. The smaller flaps 404 are configured to be smaller than the apertures defined between the spokes 604 of the pinwheel spacer 506 such that the smaller flaps 404 when positioned appropriately do not contact the spokes 604 or the outer ring 602 of the pinwheel spacer 506. This allows the smaller flaps 404 to flex towards the pinwheel spacer. In this way, the larger flaps 402 are configured to flex one direction (e.g., outward) and the smaller flaps 404 are configured to flex in the other direction (e.g., inward). Advantageously, by embedding the smaller flaps 404 in the larger flaps 404, the surface area of surface area of the baffle 400 is well utilized. This is because air is forced against a large portion of the first side of the baffle 400 when the larger flaps 402 flex in the first direction. Additionally, air is forced past a large portion of the second side of the baffle 400, reverse of the first side, when the smaller flaps 404 flex in the second direction. The baffle 400 has an antipathogen layer on both sides and acts a pseudo exhaust valve along with the filter.

In an example, the fine mesh layers 503, 507, 508 are a thin cotton layer to contain any filter layer fibers and provide a clean outer surface. In an example, the filter layer 502 is a cotton batting filter layer or alternate N95 type spun polyester non-woven filter material. In an example, the fine mesh layer 503 between the ring spacer 506 and the filter layer 504 keeps the material of the filter layer 502 spaced from the baffle 400 to allow space for the flaps 402, 404 of the baffle 400 to flex. In an example, the baffle 400 is composed of a polymer, such as Kapton, polyester, polyolefin, LC with copper on both sides. In an example, the slots defining the flaps 402, 404 in the baffle 400 are 1 mm across. In an example, the pinwheel spacer layer 506 allows the major (larger) flaps 402 of the baffle 400 to flex outward during exhale and allows the interior (smaller) arrowhead shaped flex flaps 404 to flex inward during inhale. The pinwheel spacer 506 can be a molded part to provide contour support and keep the filter layer 502 from bunching or trying to impede the flex features from moving. In an example, the fine mesh layer 508 on the outside of the pinwheel spacer 506 can enclose the baffle 400.

As described above, the major flex flaps 402 of the baffle 400 reside on the webs of the pinwheel spacer 506 which will prevent inward flexure during inhale, while the spacer ring 504 provides space for the major flaps 402 to flex during exhale. The interior flex flaps 404 can flex inward during inhale and will likely be subordinate during exhale. In an example, the airstream flow through the filter layer 502 during inhale and exhale while driving the airflow in contact with the exposed antipathogen layers on the baffle 400 as much as possible without restricting too much airflow without large perforations. Although only a single baffle 400 is shown, in other example, multiple baffles and corresponding ring spacers, pinwheel spacers, are disposed Another copper circuit layer (e.g., copper flex layer 3308) can be added to increase the anti-pathogen effect. Although a specific geometry for the flaps 402, 404 of the baffle 400 is shown and described, other geometries having flexible flaps can be used.

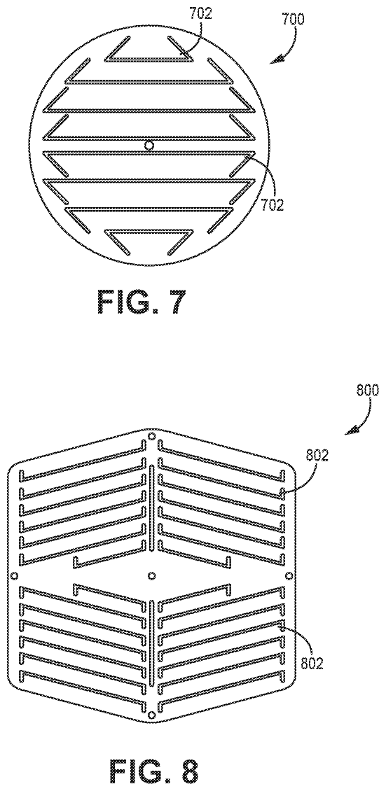

FIG. 7 is another example baffle 700 having flexible flaps 702 therein. FIG. 8 is yet another example baffle 800 having flexible flaps 802 therein. It should be understood that other shapes, sizes, and configurations of flaps can also be used,

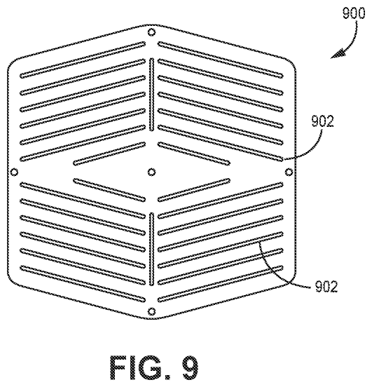

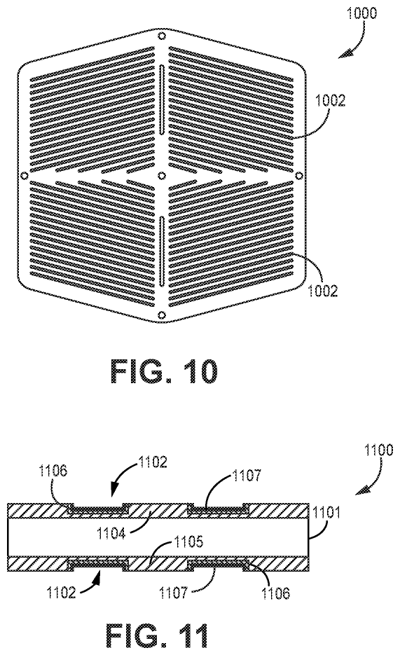

FIG. 9 is another example baffle 900 having a plurality of apertures 902 defined that extend through the baffle 900, In this example, the apertures 902 have the shape of elongated slots. In other examples, the apertures 902 can have other shapes. In any case, the apertures 902 are dispersed throughout the baffle 900 and provide passages for air to flow through the baffle 900 from one side to the other. The baffle 900 can be disposed in a larger airflow path or paths that are, or combine to, cover a similar area as that of the baffle 900. The apertures 902 can provide a net airflow path and be appropriately sized such that the airflow incident on the baffle 900 has some resistance but is allowed to pass through the apertures 902 to the other side of the baffle 900. The resistance will force air incident on the baffle 900 to flow against the antipathogen surface of the baffle 900 on its way to the apertures 902. Accordingly, the apertures 902 are sized and disposed to allow air to flow across the antipathogen surface of the baffle 900. FIG. 10 is another example baffle 1000 having a plurality of apertures 1002 defined therein. It should be understood that other shapes, sizes, and configurations of apertures can also be used.

FIG. 11 is a cross-sectional view of an example baffle 1100 having topographical features providing topographical variation in the antipathogenic surface. In this example, the topographical variation is recesses 1102 defined in the antipathogen layers 1104, 1106 therein. In this example, the antipathogen layers 1104, 1105 are disposed on a substrate 1101. In this example, the plurality of recesses 1102 and antipathogen layers 1104, 1106 are on both sides of the baffle 1100. In other examples, the recesses 1102 and antipathogen layers 1104, 1106 are only on a single side. The recesses 1102 can have a depth that does not extend below the antipathogen layers 1104, 1106, such that the sidewalls and bottom of the recesses 1102 are exposed antipathogen material. The topographical variation increases the surface area of the antipathogen material and provide roughness which can aid causing the pathogens in the air to come into contact with the surface.

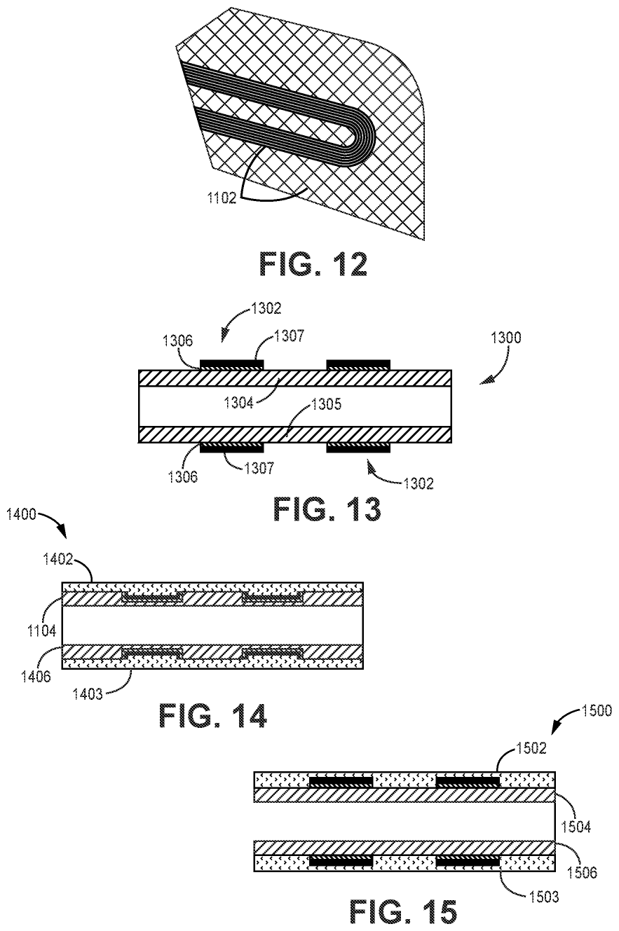

FIG. 12 is a top view of a plurality of an example of such recesses 1102. In this example, the recesses 1102 have the shape of elongated grooves. Any number and location of recesses/grooves 1102 can be used. In an example, parallel grooves are included (e.g., on substantially all) exposed antipathogen surfaces of a baffle. In an example, the recesses/grooves 1102 are less than 100 microns deep, such as 10 microns deep in an 18 micron thick antipathogen layer. The recesses/grooves 1102 can be less than 500 microns wide, or less than 250 microns wide or less than 100 microns wide. In an example, the recesses/grooves 1102 are 75 microns wide. In an example, adjacent recesses/grooves 1102 are less than 500 microns apart, less than 250 microns apart, less than 100 microns apart. In an example, the recesses/grooves 1102 are less than 75 microns apart. Other dimensions are also possible for the recesses/grooves 1102.

In some examples, there are no additional materials in the recesses 1102, such that the inside surfaces of the recesses 1102 are the same material as the rest of the antipathogen surface of the baffle 1100. In the example shown in FIG. 11, additional materials are disposed (e.g., deposited) in the recesses 1102 to enhance the antipathogenic properties. For example, a layer of nickel 1106, 1107 can be deposited on top of a base copper layer 1104, 1105 in the recesses 1102. A layer of zinc 1108, 1109 can then be deposited overtop of the nickel layer 1106, 1107 in the recesses 1102. This results in portions of the copper being exposed alongside exposed zinc creating an oxidation reaction between the two substances in the presence of moisture (e.g., water droplets). The nickel is used to plate the zinc on the copper in a way that reduces attach of the copper by the zinc. In another example, a base zinc layer is used with copper added to the zinc and having exposed copper next to exposed zinc. In other examples, other additional antipathogen materials can be used.

FIG. 13 is a cross-sectional view of another example of a baffle 1300 having topographical variation. Baffle 1300 includes rises 1302. Each rise 1302 is an area in which antipathogen material extends above the normal surface of the antipathogen layer 1304, 1306. In an example, the rises 1302 are elongated lines (e.g., a plurality of parallel raised lines) on the antipathogen layer. In an example, the rises 1302 are composed of the same material as the base antipathogen layers 1304, 1306 (e.g., copper). In the example shown in FIG. 13, the rises 1302 are composed of a layer of zinc 1308, 1309 on top of a layer of nickel 1306, 1307, which is disposed on the antipathogen copper layer 1104, 1106. In other examples, other materials can be used. As should be understood a combination of recesses 1102 and rises 1302 can be used on a single antipathogen surface.

FIGS. 14 and 15 are cross-sectional views of other example baffles 1400, 1500 having a reaction enhancing coating 1402, 1403, 1502, 1503 on the antipathogen layer 1404, 1406, 1504, 1506. In these examples, the coating 1402, 1403, 1502, 1503 also covers the topographical features defined in the antipathogen layers 1404, 1406, 1504, 1506. In an example, the reaction enhancing coating is a saline that is applied over a copper layer with zinc in the recesses or on the rises. The saline is dried so that dried salts reside on the exposed copper and zinc surfaces. While the surfaces remain dry, the oxidation reaction is paused, and the salt remains dried. As the surface is exposed to moisture (e.g., a user's breath) the salt dissolves and jump starts the metal free ion exchange during oxidation creating a mild voltage self-generating battery effect. This can be highly effective at disabling viruses. The saline adds sodium and chloride ions that drive the oxidation corrosion which is the basic chemical reaction that destroys the virus's ability to replicate.

Any of the baffles described herein can be planar (i.e., flat) or can have a three-dimensional geometry (e.g., a concave or convex shape). In an example, the substrate of the baffle is a polymer layer formed by extrusion and is initially flat. In an example, the polymer layer substrate is initially between 1 and 1000 microns thick and can have any suitable length and width. The polymer layer can then be plated, using circuit board fabrication techniques, with an antiviral material, such as silver or copper. The metal bearing film can be subject to etching and deposition techniques to form the recesses and/or rises on the antipathogen surface. The metal bearing film can also be die cut or otherwise processed to create any flaps or apertures therein. After extrusion and formation of the antipathogen layers and any recesses, rises, flaps, or apertures, the fabricated substrate can be subject to thereto-elastic processing to form the flat sheet into a three-dimensional shape as desired.

Any of the features described herein can be mix and matched, with the basic principle of cutting slits or material separations that allow for air flow but reduce the effective gap to provide contact to the antiviral material exposed on the surface. The net airflow effect can be set by adjusting the pattern and/or size of slits, flaps, or apertures. The LCP can also be treated with a plasma deposited monomer to create anti-wetting characteristics where desired, as well as microfluidic channels can be added to control and direct fluid or moisture accumulation.

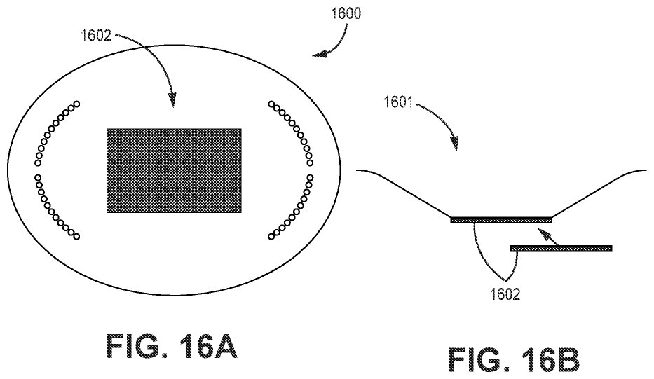

Any of the baffles herein can be formed in a polymer material that is contiguous with the main body 102 or can be formed in a cartridge that is removably secured to the main body 102. FIG. 16A is front view of an example facepiece 1600 having a baffle 1602 formed in polymer layers that are contiguous with the main body. FIG. 16B is a cross-sectional view of a facepiece 1601 having an exchangeable baffle cartridge 1602 removably secured thereto. The baffle cartridge 1602 can include a baffle as described in any of the examples herein. The main body 1604 to which the cartridge is removably secured can also be composed of one or more layers of a thermoelastic polymer or can be composed of another material. Forming the baffle in a cartridge 1602 enables the cartridge 1602 to be exchanged with a new cartridge as desired. The cartridge 1602 can be removed, replaced, cleaned, sanitized etc. Although an example size and geometry of the cartridge is shown in FIG. 16B, cartridge 1602 can have any suitable size or geometry. Example cartridges in which a baffle can be formed and facepieces in which those cartridges can be used are provided in PCT patent application no. PCT/US21/29764 filed on Apr. 28, 2021 and titled “ANTIPATHOGEN RESPIRATOR”.

The antipathogen baffle placed within the airflow path in some fashion has significant advantages over the methods used to incorporate particles, threads, or coatings within a facepiece. Those methods have a relatively small density of anti-microbial or antiviral material relative to the actual material content of the mask and corresponding airflow volume. In other words, the vast majority of the airflow and airborne pathogens pass through the untreated areas of the fabric. The use of a surface bearing anti-pathogen properties significantly increases the probability of any airborne pathogen encountering the surface and remaining in a disabled state no longer able to infect or replicate. Since the airborne pathogen are essentially caried by moisture droplets large and small, the surface can be enhanced to promote pathogen capture and prolong the duration of direct contact with the anti-pathogen measures.

What is claimed is:

1. A facepiece comprising:
a main body having a geometry configured to fit on a human face and cover the human's mouth and nose, the main body defining an interior cavity between the main body and the human's face;
one or more straps extending from the main body and configured to extend around the ears or head of a human such that the main body is held on the human's face; and
one or more baffles disposed on the main body and in an airflow path between the interior cavity and an external environment, the one or more baffles having a first surface disposed to deflect air traveling along the airflow path, the first surface having a metal layer exposed to air traveling along the airflow path.

2. The facepiece of claim 1, comprising:
a filter material disposed in the airflow path between the interior cavity and an external environment, wherein the filter material is certified to meet the N95 standard for pathogen filtration in the United States of America.

3. The facepiece of claim 1, wherein the metal layer includes one or more of copper, silver, and zinc.

4. The facepiece of claim 1, wherein the one or more baffles define a plurality of flaps, the plurality of flaps configured to flex at least one of inward or outward in response to force on the flaps caused by air flow during at least one of inhaling or exhaling while the mask is being worn, wherein the metal layer is on at least a portion of a surface of each of the plurality of flaps.

5. The facepiece of claim 4, wherein the plurality of flaps include a plurality of larger flaps and a plurality of smaller flaps, the plurality of smaller flaps defined within the plurality of larger flaps.

6. The facepiece of claim 1, wherein the metal layer defines a plurality of topographical features therein.

7. The facepiece of claim 6, wherein the plurality of topographical features include one or both of a plurality of recesses and a plurality of rises.

8. The facepiece of claim 7, wherein the plurality of recesses include a plurality of elongated grooves and the plurality of rises include a plurality of raised lines.

9. The facepiece of claim 1, wherein the metal layer includes multiple metals in contact with one another, the multiple metals selected from the group consisting of: copper, silver, nickel, and zinc.

10. The facepiece of claim 9, comprising dried salts disposed on the metal layer.

11. The facepiece of claim 10, wherein the baffles define a plurality of slits, the plurality of slits providing a passage for airflow through the one or more planar substrates.

12. The facepiece of claim 1, wherein an overall geometry of the baffle is rigid.

13. The facepiece of claim 1, wherein the baffles are planar.

14. The facepiece of claim 1, wherein the baffles are curved.

15. The facepiece of claim 1, wherein an overall geometry of the baffles is flexible.

16. The facepiece of claim 1, wherein the baffles are removable from the main body.

17. A facepiece comprising:
a main body having a geometry configured to fit on a human face and cover the human's mouth and nose, the main body defining an interior cavity between the main body and the human's face;
one or more straps extending from the main body and configured to extend around the ear's or head of a human such that the main body is held on the human's face; and
one or more filters disposed on the main body and in an airflow path between the interior cavity and an external environment, the one or more filters having a first surface disposed to deflect air traveling along the airflow path, the first surface having an antipathogenic layer exposed to air traveling along the airflow path.

18. The facepiece of claim 17, wherein the antipathogenic material includes one or more of copper, silver, and zinc.

19. The facepiece of claim 17, wherein the facepiece is a facemask.

20. The facepiece of claim 17, wherein the facepiece is a respirator.
